(19) United States
(12) Patent Application Publication
(10) Pub. No.: US 2008/0164371 A1
(43) Pub. Date: Jul. 10, 2008

(54) SYSTEM AND METHOD FOR CONVERTING A PASSENGER AIRCRAFT TO A CARGO AIRCRAFT

(76) Inventor: William J. Wagner, Valley Center, CA (US)

Correspondence Address: David P. Cooper;Kolisch Hartwell, P.C., 200 Pacific Building, 520 S.W. Yamhill Street, Portland, OR, 97204, US

(21) Appl. No.: 12/051,291

(22) Filed: Mar. 19, 2008

Related U.S. Application Data
(63) Continuation of application No. 11/728,682, filed on Mar. 26, 2007, now abandoned.
Application No. 11/728,682 is a continuation of application No. 11/159,826, filed on Jun. 22, 2005, now abandoned.
(60) Provisional application No. 60/583,038, filed on Jun. 24, 2004.

(51) Int. Cl. B64C 1/20

(52) U.S. Cl. 244/118.1

(57) ABSTRACT

An aircraft-conversion method of converting a passenger aircraft to a cargo aircraft, includes selecting a passenger aircraft, and converting the aircraft to a cargo aircraft by changing a door of the aircraft to accommodate loading and unloading of cargo. The selecting step may involve an all-passenger aircraft, and the converting step may include removing all seats from the aircraft. A system for converting a passenger aircraft with a passenger door for passenger entry and exit to a cargo aircraft includes aircraft-door conversion structure constructed to replace the passenger door with a cargo door that allows loading and unloading of cargo on the aircraft via the cargo door. A converted cargo aircraft includes an aircraft body, and aircraft-door conversion structure constructed to replace the passenger door with a cargo door that allows loading and unloading of cargo on the aircraft via the cargo door.

### CROSS-REFERENCE TO RELATED APPLICATIONS

This application is a continuation of U.S. patent application Ser. No. 11/728,682, filed Mar. 26, 2007 and entitled “System and Method for Converting a Passenger Aircraft to a Cargo Aircraft”, which application is a continuation of U.S. patent application Ser. No. 11/159,826, filed Jun. 22, 2005 and entitled “System and Method for Converting a Passenger Aircraft to a Cargo Aircraft”, which application claims priority to U.S. Provisional Patent Application Ser. No. 60/583,038, filed Jun. 24, 2004 and entitled “System and Method for Converting a Passenger Aircraft to a Cargo Aircraft”, which is incorporated herein by reference.

### SUMMARY OF INVENTION

One feature of the invention is an aircraft-conversion method of converting a passenger aircraft to a cargo aircraft, and that method includes selecting a passenger aircraft, and converting the aircraft to a cargo aircraft by changing a door of the aircraft to accommodate loading and unloading of cargo. The selecting step may involve an all-passenger aircraft, and the converting step may include removing all seats from the aircraft.

Another feature of the invention is a system for converting a passenger aircraft with a passenger door for passenger entry and exit to a cargo aircraft includes aircraft-door conversion structure constructed to replace the passenger door with a cargo door that allows loading and unloading of cargo on the aircraft via the cargo door.

Another feature of the invention is a converted cargo aircraft includes an aircraft body, and aircraft-door conversion structure constructed to replace the passenger door with a cargo door that allows loading and unloading of cargo on the aircraft via the cargo door.

### DETAILED DESCRIPTION OF THE PREFERRED EMBODIMENT

Referring to Attachment A, there is a detailed description of the invention including the preferred embodiment.

I claim:

1. An aircraft-conversion method of converting a passenger aircraft to a cargo aircraft, comprising:
selecting a passenger aircraft; and
converting the aircraft to a cargo aircraft by changing a door of the aircraft to accommodate loading and unloading of cargo.

2. The method of claim 1, wherein the selecting step involves an all-passenger aircraft.

3. The method of claim 1, wherein the converting step includes removing all seats from the aircraft.

4. A system for converting a passenger aircraft with a passenger door for passenger entry and exit to a cargo aircraft, comprising:
aircraft-door conversion structure constructed to replace the passenger door with a cargo door that allows loading and unloading of cargo on the aircraft via the cargo door.

5. A converted cargo aircraft, comprising:
an aircraft body;
aircraft-door conversion structure constructed to replace the passenger door with a cargo door that allows loading and unloading of cargo on the aircraft via the cargo door.
